(19) United States
(12) Patent Application Publication
(10) Pub. No.: US 2013/0164451 A1
(43) Pub. Date: Jun. 27, 2013

(54) Method and Arrangement for Depositing a Metal Coating

(71) Applicants: Helmut Bruckner, Eitorf (DE); Andreas Skupin, Herpersdorfer Strasse (DE); Christian Lowinski, Berlin (DE); Bernhard Schachtner, Potsdam (DE)

(72) Inventors: Helmut Bruckner, Eitorf (DE); Andreas Skupin, Herpersdorfer Strasse (DE); Christian Lowinski, Berlin (DE); Bernhard Schachtner, Potsdam (DE)

(21) Appl. No.: 13/809,257

(22) PCT Filed: Jul. 6, 2011
(86) PCT No.: PCT/EP2011/061448

§ 371 Date: Feb. 25, 2013

(30) Foreign Application Priority Data
Jul. 9, 2010 (DE) 102010031181.2

(51) Int. Cl. B05C 11/00; B05D 1/18

(52) U.S. Cl. CPC B05C 11/00; B05D 1/18
USPC 427/430.1; 118/610

(57) ABSTRACT

A method for depositing a coating of a first metal onto a workpiece 12 which exposes a second metal by a) providing a bath liquid 16 containing components containing ions of the first metal to be deposited, at least one complexing agent for the second metal and at least one acid, b) depositing the coating of first metal from the bath liquid 16 onto the workpiece 12, c) feeding the bath liquid 16 into a tank 18, d) cooling the bath liquid 16 in the settling tank 18 for generating a precipitate and filtrate, the precipitate comprised of the second metal and the at least one complexing agent, f) returning the filtrate to the bath liquid 16 and g) replenishing bath components to the bath liquid 16. In separating precipitate from the filtrate a pressure difference is generated by the filter.

The invention relates to a method for depositing a coating of a first metal onto a second metal of a workpiece wherein a precipitation is generated by the cooling of a bath liquid, which precipitate is removed by filtration. Moreover the invention relates to an arrangement for the execution of said method.

In the manufacture of circuit boards, tin and tin alloy coatings are deposited for different purposes onto the copper surfaces, for example as contact surfaces for electronic components.

Firstly, tin layers and tin alloy coatings serve as a solder depot on the circuit board surface in areas, to which electronic components are to be soldered. In these cases such layers are applied locally in those areas in which contact wires or other connecting elements of the components are to be electrically bonded to the copper surface. After the soldered areas have been formed on the copper surfaces the components are placed on the solder depots and secured there. The solder is then melted in a furnace so that the electrical connections can form. These layers further serve to maintain the copper surface in a solderable form during storage. Secondly, very thin coatings of tin and tin alloy, for example of around only 1 μm in thickness, can be produced. These do not represent a solder depot but form a wettable tin surface on a copper structure. When marking with a solder depot-forming solder paste, the solder paste adheres to the wettable tin surfaces.

Tin layers can also be used as etch-protection layers, for example to form the circuit pattern on the surfaces of the circuit boards. For this purpose, a negative image of the circuit track pattern is first formed with a photostructureable resist on the copper surface. A tin or tin alloy coating is then deposited in the channels of the resist coating. After removal of the resist, exposed copper can be removed by etching so that only the circuit tracks and all other metal patterns beneath the tin and/or tin alloy coating are left behind on the surfaces of the circuit board.

Tin coatings are also used as intermediate coatings between the copper surfaces of the inner layers of multilayer circuits and the dielectric layers (usually glass-fiber reinforced resin coatings). For an adhesive bonding of the copper surfaces with the dielectric it is necessary to abrade the copper surfaces before pressing to obtain a sufficient adhesion between copper and resin. For this purpose it would be possible to oxidise the surfaces with a so-called black oxide method. The oxide coating formed in the process is not sufficiently resistant to acids however, so that the inner layers that are cut-into when drilling the circuit board material become detached, thus forming delaminations from the resin of the circuit board material. This problem is avoided with the use of tin coatings in place of the black oxide coatings. In terms of manufacture, the tin coatings are deposited cementatively directly onto the copper surfaces of the circuit tracks. In a post processing stage, if necessary further adhesive compounds are applied to the tin coatings (for example a mixture of a ureido silane with a disilane wetting agent (EP 0 545 216 A2), before the inner layers are pressed together under the effect of heat and pressure.

While the tin and/or tin alloy coatings can be electrolytically deposited for the second application because no electrically-insulated metal areas are to be tinned, tin cannot be deposited with an electrolytic method in the first and latter cases because the copper surfaces to be metallised are generally electrically insulated with respect to one another and electrical bonding is therefore practically impossible. For this reason, so-called cementation baths are provided for tin precipitation.

U.S. Pat. No. 4,715,894 discloses one such deposition bath. This bath contains, in addition to a Sn(II) compound, a thiourea compound and a urea compound. According to EP 0 545 216 A2, thiourea, urea and the derivatives thereof can also be used as alternatives to one another. Furthermore, the solution in accordance with U.S. Pat. No. 4,715,894 can also contain a complexing agent, a reducing agent and an acid. SnSO₄ can be used for example in accordance with U.S. Pat. No. 4,715,894 as a Sn(II)compound. According to EP 0 545 216 A2 the bath contains Sn(II) compounds of inorganic (mineral) acids, for example compounds of acids containing sulfur, phosphorus or halogen or of organic acids, for example Sn(II) formate and Sn(II) acetate. According to the teaching in EP 0 545 216 A2 the Sn(II) salts of sulfur containing acids are preferred, in other words the salts of sulfuric acid and amidosulfuric acid. The bath may otherwise contain alkali metal stannates, such as sodium or potassium stannate. Furthermore, the thiourea and urea compound relate in the simplest case to the non-substituted derivates of thiourea and/or urea. According to the teaching in EP 0 545 216 A2, Cu(I) ions are formed during the deposition of tin onto the copper surfaces, which ions are complexed by thiourea. At the same time metallic tin is deposited by reduction of Sn(II) ions. Copper is dissolved during this reaction and simultaneously a tin coating is formed on the copper surfaces. WO 01/34310 A1 further discloses a method for non-galvanic tin coating. The coating bath contains thiourea and/or the derivates thereof as the complexing agent. Methane sulfonic acid can be added to the bath as the acid.

EP 0 545 216 A2 reports that the Cu(I)-thiourea complex is enriched in the solution, while the concentration of thiourea falls. In addition, Sn(IV) ions are enriched in the solution by oxidation of Sn(II) ions because the oxygen from the air is introduced into the solution. However, the concentrations of the Cu(I)-thiourea complex and of the Sn(IV) ions do not increase beyond stationary concentration values if circuit boards are only immersed in the solution for treatment because bath solution is constantly carried out by the boards and the bath is diluted by water which is carried in. If the bath liquid is sprayed onto the copper surfaces through nozzles, however, a substantially greater process material turnover is achieved in relation to the bath volume. Under these conditions the concentration of the Cu(I) thiourea complex increases such that its saturation point is reached and the complex is precipitated as a precipitate. The precipitate blocks the nozzles and causes problems in moving mechanical parts of the system. In order to resolve this problem it is proposed that a part of the bath liquid is separated, cooled and the resulting precipitate of insoluble Cu(I) thiourea complex is separated out, for example filtered out.

The bath liquid must be continually replenished with ingredients which can be consumed by chemical reaction or by carry-out of the bath liquid. This is a problem particularly for components with limited solubility. For instance, thiourea exhibits a solubility of around 90 g/l at 20° C. The concentration of thiourea in the liquid added to the bath liquid to supplement thiourea is thereby effectively limited to 80 g/l. This in turn means that the thiourea which is consumed by the precipitation of the Cu(I) must be added as a solid. The dissolving behavior of solid thiourea however makes exact dosing of the thiourea and homogenisation of the bath liquid difficult.

It is possible to replenish components of the bath liquid by continually introducing new bath liquid into the bath while continually and simultaneously removing bath liquid in an equal quantity. This so-called “bleed and feed” method is in fact a simple method of controlling the composition. However, since components are continually added to the bath and are removed from the bath and must be disposed of, this method is very expensive.

The object of the invention is therefore to create a method which simplifies the addition of the bath components, particularly of thiourea, and of the bath feed overall.

The object is achieved by the subjects of the invention pursuant to the independent claims 1 and 13. Beneficial embodiments are specified in the dependent claims.

The method in accordance with the invention serves for depositing a coating of a first metal onto a workpiece which exposes a second metal. The method comprises the following steps:
a) providing a bath liquid; the bath liquid contains bath components, which bath components comprise ions of the first metal to be deposited, for example a salt of the first metal, at least one complexing agent for (ions of) the second metal and at least one acid;
b) depositing the coating of the first metal from the bath liquid onto the workpiece;
c) feeding the bath liquid into a settling tank;
d) cooling the bath liquid in the settling tank in order to generate a precipitate and a filtrate, the precipitate comprising the second metal (in the form of its ions) and at least one complexing agent;
e) separating the precipitate from the filtrate using a filtration apparatus;
f) returning the filtrate to the bath liquid; and
g) replenishing bath components to the bath liquid.

The method in accordance with the invention is characterised in that, for separating the precipitate from the filtrate, a pressure difference is generated via the filter. The pressure difference can be generated by creating a vacuum at the filtrate end and/or by applying an overpressure at the end of the solution to be filtered. If a vacuum is applied at the filtrate end, one speaks of vacuum filtration. If excess pressure is created at the end of the solution to be filtered, one speaks of pressure filtration. The two methods can also be combined to generate a pressure difference. Particularly beneficial is the separation of the precipitate from the filtrate using pressure filtration, if necessary with additional use of vacuum filtration because by means of vacuum filtration alone (in other words, without using pressure filtration) the maximum possible pressure difference that can be generated is only approximately 1 bar while a greater pressure difference can be generated using pressure filtration. By this means it is possible firstly to increase the flow rate. Secondly the filter cake exhibits a smaller liquid content at a higher pressure difference such that the recovery of the bath components is optimized by pressure filtration.

The application of pressure filtration for the separation of the precipitate from the filtrate simplifies the feed of bath components, particularly of less soluble bath components. This is because a significantly higher quantity of bath liquid can be recovered during the separation of the precipitate from the filtrate. The filtrate contains valuable bath components. The return flow of the filtrate into the bath means that the feed, particularly of less soluble bath components, is therefore reduced to a minimum and the bath replenishment is thereby simplified. This is because fluctuation of the liquid content of the sludge returning into the bath without pressure filtration would result in increased analytical monitoring of the bath in order to continuously determine the concentrations of bath components or else it would have to be taken into account that the concentration of the bath components would continuously severely fluctuate. This is a substantial benefit in the present case because the separated precipitate is a precipitate being precipitated by cooling from a complex of the second metal and the complexing agent. This precipitate in generated in the case of the precipitation by cooling as sludge with a very high liquid content. By means of the pressure filtration in accordance with the invention of said sludge, the process costs of the recovery of the bath liquid in the form of the filtrate from the precipitate can be substantially reduced. It has furthermore been surprisingly shown that the filtrate contains all substantial bath components while any contaminants which might be present in the bath liquid are to be found in the precipitate. By application of the pressure filtration, the sludge is largely dewatered and separated from the process materials of the filtrate and thereby dried, while contaminants are separated. The contaminants predominantly originate in materials used in the manufacture of the circuit boards. Examples include materials of the solder resist masks, marking materials and materials for improving adhesion. Adhesion improvers are designed for instance to improve the adhesion between copper and the prepreg or between the solder resist mask and the copper surface. Contaminants can also originate from materials used for example for stiffening or for subsequent cooling. One example of a material which can be used for subsequent cooling is aluminum. In addition, many materials contain fillers, particularly barium sulfate, silicon dioxide or aluminum oxide. These can also be released and can contaminate the bath. There are also remains of mechanical cleaning, for example pumice. All these substances can be precipitated with the precipitate and can therefore be removed from the bath by filtration. Any increase in the concentration of these materials within the bath will lead to a gradual deterioration of the efficiency and throughput, particularly of the deposition speed and wetting properties. Filtration can counteract these problems.

The bath liquid is preferably cooled in the processing step d) from a bath temperature of from 20 to 30° C. to a temperature of below 10° C., preferably from 4 to 8° C., particularly to approx. 6° C. This reduces the solubility of the precipitate comprised of the second metal and the complexing agent such that precipitation ensues.

In a preferred embodiment of the method in accordance with the invention the precipitate is separated by means of a chamber filter press. A chamber filter press comprises a series of filter segments which filter segments comprise a filter cloth as a separating means, wherein the filter cloth lines the interior of the segment. By this method a large effective area is achieved for filtration. Furthermore, the segments are pressed together under high pressure, typically 100 bar and more, (closing pressure), such that the segments close tightly together even during the introduction under overpressure of the liquid to be filtered. The segmented structure means that cleaning is very quick and easy such that a filter cake engendered by the precipitate can be removed quickly and efficiently from the filter press. For this purpose the segments are moved apart and the filter cake, which is practically dry due to the high pressure under which the fluid to be filtered is introduced into the chamber filter press, can be efficiently removed. Such chamber filter presses are known in the area of wastewater treatment technology and are manufactured by Andritz AG, AT amongst others.

In a further preferred embodiment of the method in accordance with the invention the precipitate is separated at a pressure of from 9 to 16 bar. Firstly in this pressure range the forces acting on the filtration apparatus are not sufficiently large as to destroy the apparatus in the event of increasing flow resistance due to the developing filter cake. Secondly however the pressure in this pressure range is high enough to recover as much filtrate as possible from the sludge-like precipitate.

In a further preferred embodiment of the method in accordance with the invention, tin is selected as the first metal. Particularly preferred is tin in the form of Sn(II) ions. Particularly preferred are Sn(OCOCH₃)₂ and the tin (II) salts of toluene sulfonic acid, of methane sulfonic acid, of derivates of methane sulfonic acid, including of substituted methane sulfonic acid, and of aromatic sulfonic acids, particularly of phenol sulfonic acid.

In a further preferred embodiment of the method in accordance with the invention, the second metal is copper of which, for example, the circuit tracks or contact areas of a circuit board are comprised.

Tin is deposited in the presence of the complexing agent onto copper since copper dissolves with the forming of a copper(I)/complexing agent complex. This method takes place without electric current.

In a further preferred embodiment of the method in accordance with the invention urea (CH₄N₂O, CAS [57-13-6]), thiourea (CH₄N₂S, CAS [62-56-6]) or the derivates thereof are selected as complexing agents. Examples of these derivates are N-alkylurea, N-alkylthiourea, N,N-dialkylurea, N,N-dialkylthiourea, N,N′-dialkylurea and N,N′-dialkylthiourea, wherein alkyl is selected in the moieties respectively independently of one another from the group comprising methyl, ethyl, propyl, methylethyl, butyl, 1-methyl propyl, 2-methyl propyl and dimethyl ethyl. Examples for aromatic derivates are N-arylurea, N-arylthiourea, N,N′-diarylurea and N,N′-diarylthiourea, wherein aryl is selected in the moieties respectively independently of one another from the group comprising phenyl, benzyl, methylphenyl and hydroxyphenyl.

In a further preferred embodiment of the method in accordance with the invention at least one acid is selected from the group comprising methane sulfonic acid, derivates of methane sulfonic acid, including substituted methane sulfonic acid, as well as aromatic sulfonic acid, particularly phenol sulfonic acid. Particularly preferred is methane sulfonic acid since this exhibits a high solubility and gives rise to the generation of the precipitate with the lowest liquid content. Furthermore, the solubility of a copper/thiourea complex in a bath liquid containing methane sulfonic acid is substantially greater, namely approx. 8 g/l at 20° C., than if the bath liquid contains toluene sulfonic acid, namely only approx. 2 g/l at 20° C. The better solubility in the bath liquid containing methane sulfonic acid is beneficial because this reduces the danger of the copper/thiourea complex being precipitated in the bath liquid as precipitate.

In a further preferred embodiment of the method in accordance with the invention during filtration a precipitate, preferably a filter cake, is generated, which precipitate has a copper content of at least 5% by weight, particularly preferably of at least 7% by weight and most preferably of at least 8% by weight. This permits firstly an efficient return feed of the bath liquid in the form of the filtrate and secondly an optimum further treatment and recovery of process materials from the filter cake.

In a further preferred embodiment of the method in accordance with the invention filtration takes place using a filter cloth. The filter cloth is preferably woven from polypropylene fibers. The benefit of filter cloths made of polypropylene is the smooth surface, whereby the precipitate, particularly filter cake, is prevented from penetrating into the filter material. Additionally the mesh width can be varied in order to achieve a maximum return feed of bath liquid.

In a further preferred embodiment of the method in accordance with the invention the bath liquid is stored between the process steps d) and e) in a first storage tank. The benefit of this temporary storage is that the cooling of the bath liquid can proceed continuously while the separation of the precipitate based on the recurring removal of the precipitate, particularly of the filter cake, proceeds intermittently. Furthermore, due to the filtration the flow speed is dependent on the thickness of the precipitate formed, particularly the filter cake, and varies accordingly such that the deposition process during the formation of the precipitate in the settling tank can be kept constant, irrespective of the fluctuations it is causing in the filtration. As a further benefit it has been found that the precipitate may more easily be filtered when the first storage tank is used. This means that the filter cake contains a higher solid content and therefore fewer bath chemicals are lost than if no first storage tank is used. In addition the filtration apparatus in this case can be operated with less overpressure and therefore longer before the precipitate must be removed from the apparatus. It is assumed that the cooled bath liquid in the first storage tank has time for crystallization whereby the precipitate is easier to filter.

In order to guarantee moreover that the precipitate formed in the settling tank does not partially or fully dissolve, for example in the first storage tank, the stored bath liquid can also be cooled in a further preferred embodiment of the invention in the first storage tank. For this purpose a coolant can also be provided in the first storage tank, for instance cooling coils installed in the first storage tank, or the first storage tank comprises one or a plurality of cooled tank walls. Additionally, means of moving the bath liquid in the first storage tank may be provided, for example a stirrer, in order to guarantee as efficient a cooling process as possible. However said means should not introduce excessive movement as this would compromise the success of a coarse crystalline precipitation.

In a further preferred embodiment of the method in accordance with the invention the filtrate is stored between the process steps e) and f) in a second storage tank. The benefit of the second storage tank is that the filtrate can be fed continually to the bath and the feed of the filtrate into the bath does not vary as a result of filter cleaning or altered flow rate due to precipitation formation, particularly the formation of a filter cake. This leads to a constant level of the bath liquid in the bath tank and thereby to a simplified bath feed.

Particularly preferably, both the first as well as the second storage tank are used. This leads to a quasi-continuous operation of the filtration in the overall system.

The arrangement according to the invention used to execute the method for depositing a coating of a first metal onto a workpiece comprises at least one bath tank to hold the bath liquid for depositing the coating of the first metal onto the workpiece, an apparatus for cooling the bath liquid for generating the precipitate and a filtrate to be separated, a filtration apparatus for separating the precipitate from the filtrate and an apparatus for returning the filtrate into the bath tank. In the manner according to the invention the filtration apparatus is operable under pressure and comprises for this purpose at least one suitable means of pressure generation (e.g. pump). The means of pressure generation can be an apparatus for generating an overpressure (for the purpose of pressure filtration) or for generating a vacuum (for the purpose of vacuum filtration). For this purpose, commercially available pump systems can be used. In a preferred embodiment of the arrangement according to the invention the arrangement additionally comprises an apparatus for the removal of the bath liquid from the bath tank and for the transfer of the bath liquid to the apparatus for cooling.

The apparatus according to the invention can be arranged for one or for a plurality of bath tanks operated in parallel such that a circulation of the bath liquid through the settling tank and the filtration apparatus is assigned simultaneously to one or a plurality of bath tanks. The return feed of the filtrate to the bath solution can then be distributed in parallel to the plurality of bath tanks or fed successively to a plurality of bath tanks connected in series.

The settling tank is cooled in order to form the precipitate. In order to feed the sludge-like precipitate effectively from the settling tank into a filtration apparatus, said settling tank is formed with a downward decreasing diameter and particularly tapered. This permits an easier feed of the sludge. The settling tank is furthermore preferably surrounded by a cooling jacket. Alternatively or additionally the settling tank may also be equipped in the interior with cooling coils. In this case the wall may preferably be outwardly thermally insulated. In the settling tank furthermore, means may be provided to move the bath liquid, for example a stirrer, in order to allow an efficient heat transfer from the bath liquid to the at least one coolant.

In a further preferred embodiment of the arrangement according to the invention the arrangement additionally comprises a first storage tank connected between the apparatus for cooling and the filtration apparatus. The benefit of this temporary storage is that the cooling can proceed continuously while the separation of the precipitate based on the regular removal of the filter cake proceeds intermittently. The flow speed due to filtration is also dependent on the thickness of the formed filter cake. As a further benefit it is found that the cooled bath liquid has time in the first storage tank for crystallization whereby the precipitate is easier to filter. For this purpose, said tank may be either thermally insulated or actively cooled.

In a further preferred embodiment of the arrangement according to the invention the arrangement additionally comprises a second storage tank connected downstream from the filtration apparatus. The benefit of the second storage tank is that the feed of the recovered bath liquid to the bath tank can proceed continuously rather than varying due to filter cleaning or changed flow rate due to the filter cake formation. This leads to a constant level of the bath liquid in the bath and thereby to improved precipitation results.

Finally the arrangement according to the invention additionally comprises at least one dosing apparatus for the feed of respectively at least one bath component in order to maintain the concentrations of said bath components in the bath liquid at a constant level. The dosing apparatus may be computer-controlled.

The bath tank can be formed as a conventional immersion tank. Alternatively the bath tank may also be embodied as a treatment section in a horizontal system in which the workpieces are consecutively arranged in the horizontal or vertical alignment and moved in the horizontal feed direction. The tank may in this case be formed either as a dammed basin into which the workpieces enter at one end and out of which they are fed again at the other end or as a treatment space in which the workpieces being conveyed therein are brought into contact with the bath liquid by way of nozzles out of which the bath fluid is propelled against the workpieces. In each case the bath tanks are provided with the usual equipment, for example in an external pump-generated forced circulation system with filtration equipment, for example filter candles. The bath tanks may furthermore contain heating or cooling elements as well as equipment for moving liquid and for homogenization.

Exemplified embodiments of the invention are now described with reference to the appended figures. The individual figures show:

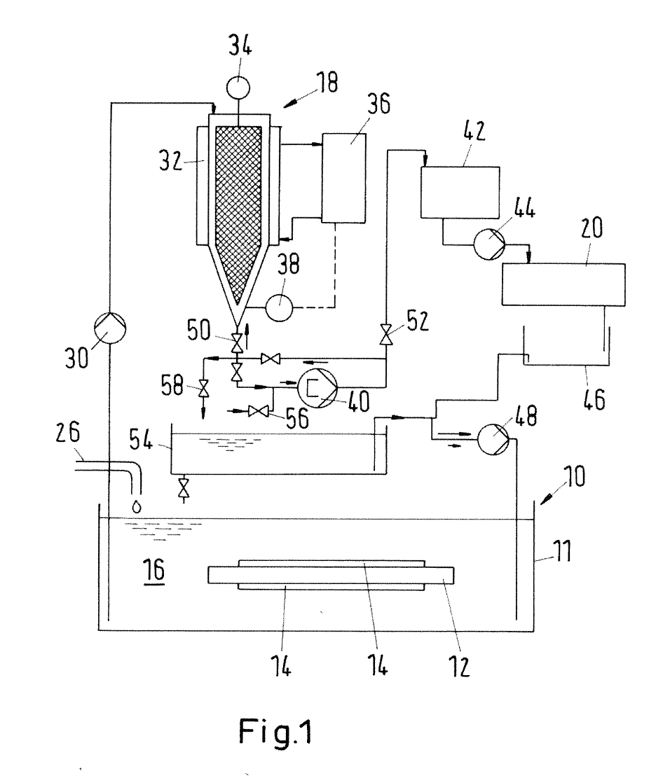

FIG. 1: a schematic view of an arrangement according to the invention with first and second storage tanks;

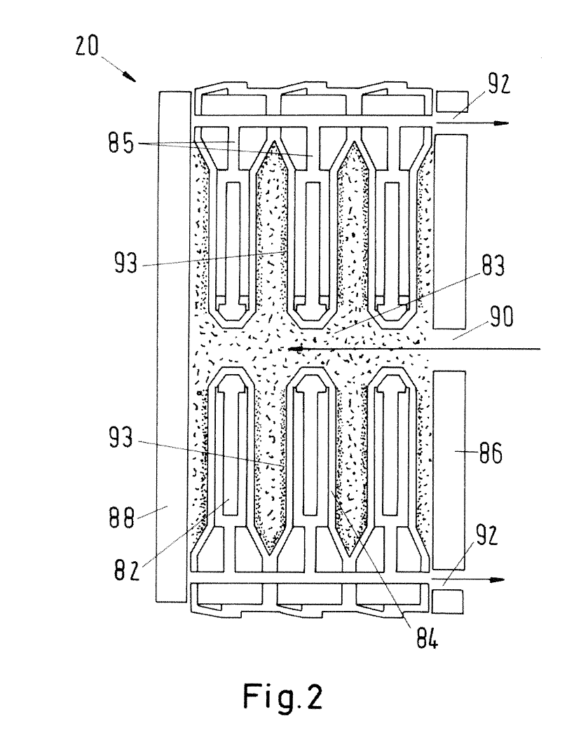

FIG. 2: a schematic cross-sectional view through a chamber filter press;

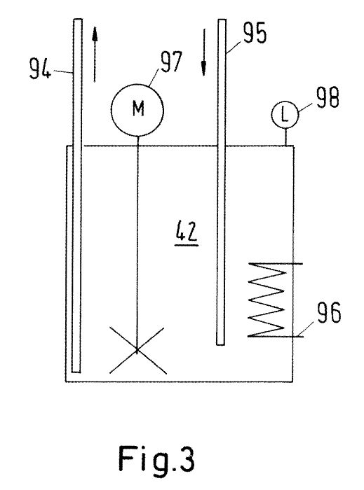

FIG. 3: a schematic view of a first storage tank.

FIG. 1 shows the schematic view of an arrangement according to the invention. In a bath 10, formed by a bath tank 11 with a bath liquid 16 being contained therein, a workpiece 12, for example a circuit board, which circuit board is coated with copper 14, is brought into contact with the bath liquid 16. The bath liquid 16 contains amongst other things the bath components Sn(II) methanesulfonate, thiourea and methane sulfonic acid. Said bath liquid 16 may further contain a reducing agent for the stabilizing of the Sn(II) ions against oxidation as well as oxidation products of said reducing agent as impurities. By means of the thiourea the redox potential of the copper 14 is changed such that tin is deposited while Cu(I) ions dissolve while being complexed with thiourea. By this means, Sn(II) ions and thiourea are consumed. The bath liquid 16 exhibits a temperature of around 20 to 30° C.

In order to remove the Cu(I)/thiourea complex from the bath liquid 16, part of the bath liquid 16 is removed from the bath tank 11 and transferred into a settling tank 18. For this purpose the bath liquid 16 is transferred by means of a first pump 30 having a volumetric flow of around 25 l/hrs into the settling tank 18. In the settling tank 18 the temperature of the bath liquid 16 is lowered such that the Cu(I)/thiourea complex precipitates. The settling tank 18 comprises a cooling jacket 32 and a stirrer 34. The cooling jacket 32 is supplied with coolant by way of a cooling unit 36. To regulate the cooling, a temperature sensor, for example a thermometer, 38 is used. By means of the cooling jacket 32 the temperature in the bath liquid 16 contained in the settling tank 18 is adjusted to around 6° C.

The bath liquid 16 being cooled to 6° C. and containing crystallized copper/thiourea complex in the form of a precipitate and therefore having a sludge-like consistency, is fed by means of a second pump 40, e.g. a peristaltic pump, into a first storage tank 42. The first storage tank 42 serves to permit continuous operation of the settling tank 18, even in phases in which the filter cake is being removed from the filtration apparatus 20 and in which the filtration apparatus is therefore not ready to receive further material to be treated. Further, the relative calm of the medium in the first storage tank 42 enables the onset of crystal growth. The construction of the first storage tank is shown schematically in FIG. 3. The storage tank exhibits a cooling apparatus 96 which is operated with cooling water, a stirring apparatus (motor M) 97 and a liquid level sensor (L) 98. Reference numeral 95 refers to the line coming from the settling tank (crystallizer) 18 and reference numeral 94 refers to the line leading to the filtration apparatus 20.

From the first storage tank 42 the bath liquid 16 is fed by a third pump 44 under a pressure of from 9 to 16 bar into the filtration apparatus 20. The filtration apparatus 20 is a chamber filter press. The bath liquid is pressed through the filter cloth under pressure. In the process a filter cake forms. The filtrate is fed back into the bath 10. For this purpose the filtrate is transferred from the filtration apparatus 20 into a second storage tank 46, from which it can be pumped using a fourth pump 48 into the bath 10. By means of the storage tank 46 a constant return feed of the filtrate and thereby a simplified bath feed is permitted.

Since the second pump 40 is connected directly downstream from the settling tank 18, said second pump 40 also comprises a flushing circuit. For this purpose the second pump 40 can also be separated from the settling tank by means of a first valve 50 and from the first storage tank 42 by means of a second valve 52. From a storage tank 54 a flushing solution, particularly an identical fluid to that of the bath liquid 16, is fed via a third valve 56 to the second pump 40 and via a fourth valve 58 back into the storage tank 54.

If the filter cake is so large and compact that as a result of the flow resistance the flow through the filter cloth with a sufficient flow rate is no longer possible the filter cake is removed from the filtration apparatus 20. After the treatment the workpiece 12 is removed from the bath 10. The coating 14 of the workpiece 12 now exhibits a coating of copper whose surface is coated with tin.

Since the composition of the bath liquid changes due to the deposition of tin and due to the consumption of thiourea to form the complex with Cu(I) ions, replenishment chemicals for the continuous operation of the bath 10 must be added to the bath liquid 16. Dosing apparatus serve for this purpose, of which a dosing apparatus 26 for the replenishment of such chemicals is schematically indicated. One such dosing apparatus typically comprises a storage tank for the replenishment chemicals, for example a solution of said chemical product, a dosing pump and a feed line for the selected feed of the chemical product into the bath liquid 16. FIG. 1 shows this apparatus solely in the form of the feed line 26.

FIG. 2 illustrates a cross sectional view through a chamber filter press 20. The chamber filter press 20 comprises filter plates 82 with a central recess 83, which filter plates 82 are adjacently disposed. The filter plates 82 are respectively covered on substantially all sides with a filter means, preferably a filter cloth 84 which consists of a PP-fabric. The primary side surfaces of the filter plates 82, which are in contact with the filter cloth 84, are studded such that between the filter cloth 84 and the spaces between the studs, which extend over a major portion of the primary side surfaces, respectively a cavity is formed beneath the filter cloth 84. These cavities are connected by way of connection channels 85 to outlet openings 92 on the filter plates 82 such that the filtrate of the filter bath is pressed through the filter cloth 84 and can flow through the outlet openings 92 into the second storage tank. The filter plates 82 are disposed between a first pressure plate 86 and a second pressure plate 88, which pressure plates 86 and 88 are pressed together with a closing pressure of around 100 bar. By this means a fluid-tight closure is achieved between the filter plates 82. The first pressure plate 86 comprises an inlet opening 90 for the suspension exiting from the settling tank 18 or from the first storage tank 42, through which inlet opening 90 the bath liquid is fed along in the direction of the arrow at a pressure of between 9 and 16 bar into the central recesses 83 of the filter plates 82 which in the operating-ready state form a central channel. The precipitate 93 settles onto the filter cloth 84 in the form of a filter cake while the filtrate exits the chamber filter press 20 by way of the cavities, the connection channels 85 and the outlet openings 92. For the cleaning of the chamber filter press 20, the pressure which is applied between the first pressure plate 86 and the second pressure plate 88 is relieved, the filter plates 82 are moved apart and the filter cake 93 adhering to the filter cloth 84 is removed from the press.

The benefits of the simplified bath feed are shown below with the help of a comparison of the conventional bath feed and the bath feed according to the invention.

### COMPARISON EXPERIMENT IN ACCORDANCE WITH EXAMPLE 1

For the precipitation of tin onto circuit boards coated with copper a bath liquid having a composition of tin (II) methanesulfonate in a concentration of 15 g/l, thiourea as the complexing agent in a concentration of 100 g/l and methane sulfonic acid in a concentration of 120 g/l was used. In addition the bath liquid contained a reducing agent for the prevention of the oxidation of Sn(II) ions.

In an arrangement which was designed for the processing of 30 m²/hr circuit boards and which comprised, in addition to a bath tank 11, a cooled settling tank 18 for the copper/thiourea complex precipitate in accordance with FIG. 1 but not the filtration apparatus 20 provided with a pressure difference having a filter cloth 84, 2.11 bath liquid was lost per hour from the bath due to drag-out as this liquid adhered to the circuit boards when they were removed from the bath. Further, due to the precipitation of copper, 144 g/hr thiourea was removed in the form of a precipitate in form of the copper/thiourea complex. An additional 306 g/hr thiourea was carried out of the bath because bath liquid adhered to the mucous precipitate of the copper/thiourea complex. Therefore 660 g thiourea per hour must be added to the bath liquid in order to maintain the thiourea concentration in the bath.

### EXAMPLE 2 ACCORDING TO THE INVENTION

For the treatment of the bath liquid according to the invention the arrangement illustrated in FIG. 1 having a chamber filter press 20 with the structure in accordance with FIG. 2 was used.

By the use of the chamber filter press 20 the sludge-like precipitate was separated into a filter cake 93 and a filtrate. The filtrate was fed back into the bath 10. With the method executed according to the invention the quantity of thiourea adhering to the precipitate could be reduced to 103 g/hr by means of pressure filtration. Thus the quantity of thiourea to be added per hour was reduced by 31% to 457 g/hr. Together with the other bath components, the saving on disposal and the simpler recycling of the filter cake constituted a cost saving of around 30%.

### EXAMPLE 3 ACCORDING TO THE INVENTION

For the treatment of the bath liquid the experimental arrangement illustrated in FIG. 1 having a first storage tank (sludge tank) 42 with the structure of FIG. 3 was used. The sludge tank contained a cooling apparatus 96, which cooling apparatus 96 was operated with cooling water (4° C.), a stirring apparatus 97 and a liquid level sensor 98. Reference numeral 95 refers to the line coming from the settling tank (crystallizer) 18 and reference numeral 94 refers to the line leading to the filtration apparatus 20.

The cooling with the cooling apparatus 96 permitted the temporarily stored bath liquid to remain cool irrespective of the ambient conditions. The sludge content (c(solid)) produced by the settling tank 18 and the residual copper content (c(Cu)) in the bath liquid were temperature-dependent. For the purpose of determining of the residual copper content and of the solid content in the bath liquid the following experiment was carried out:

7 g/l copper powder (<63 μm grain size) was additionally added to 200 l bath liquid which had a composition as in Comparison Experiment 1. At 70° C. and a residence time of around 24 hrs the copper completely dissolved in the bath liquid and the corresponding amount of metallic tin which had formed during the dissolving of the copper remained. After separation of the formed tin through filtration and replenishment of the consumed tin compounds the bath liquid exiting the crystallizer 18 was fed to the sludge tank 42. Through cooling and/or heating various temperatures were set in the sludge tank and samples were taken for analysis. The samples taken were examined for their solid content c(solid) and the residual copper content c(Cu) in the filtrate. For this purpose the 50 ml samples were sedimented in a centrifuge at 3000 rpm for 15 minutes. From the ratio of the quantity of the sediment to the total volume, the solid content c(solid) was determined in vol. %. Further samples were extracted from the supernatant in order to determine the residual copper content of the filtrate c(Cu) in g/l. Table 1 shows the measured values obtained.

TABLE 1
Copper concentration in the filtrate
and solid content in the bath liquid

| T/° C. | c(Cu)/g/L | c(solid)/vol. % |
|---|---|---|
| 0 | 1.8 | 3.8 |
| 10 | 4.1 | 2.5 |
| 20 | 5.7 | 0.5 |
| 30 | 7.1 | 0.0 |

It was found that without cooling and in higher ambient temperatures in the bath liquid, all the copper sludge re-dissolved and therefore no further separation of copper took place.

### EXAMPLE 4

To determine the copper content in the separated precipitate, the bath liquid used in Example 3 was cooled in the settling tank and the precipitate was investigated. For this purpose the bath liquid containing the precipitate was treated further to separate the precipitate in different ways:

In a first experiment the bath liquid was filtered through a suction filter by means of a pressure difference (application of a vacuum at the filtrate end) such that a very hard dry filter cake formed. In further experiments more or less wet precipitates were obtained by means of pure gravity filtration (Comparison Experiments). The precipitates obtained were then analyzed for their copper content. The experimental results are given in Table 2. The table also gives the quantities of solid matter of the respectively separated precipitate related to the quantity of precipitate in the sample filter cake.

TABLE 2
Solid content and copper content in separated precipitates

| | Solid content | Copper content |
|---|---|---|
| Sample | % by weight*) | % by weight |
| Filter cake | 100.0 | 7.2 |
| Wet sludge | 19.6 | 1.7 |
| Normally wet sludge | 24.7 | 2.0 |
| Dry sludge | 38.1 | 2.9 |

*)Solid content in relation to the quantity of the solid content in the sample filter cake

It was found that with a pure gravity filtration, i.e. without additional generation of a pressure difference, only a small separation of copper could be achieved via the precipitation.

It is understood that the examples and embodiments described herein are for illustrative purpose only and that various modifications and changes in light thereof as well as combinations of features described in this application will be suggested to persons skilled in the art and are to be included within the spirit and purview of the described invention and within the scope of the appended claims. All publications, patents and patent applications cited herein are hereby incorporated by reference.

### REFERENCE NUMERALS

10 bath
11 bath tank
12 work piece
14 copper
16 bath liquid
18 settling tank
20 filtration apparatus
26 dosing apparatus
30 first pump
32 cooling jacket
34 stirrer
36 cooling unit
38 temperature sensor
40 second pump
42 first storage tank, sludge tank
44 third pump
46 second storage tank
48 fourth pump
50 first valve
52 second valve
54 storage tank
56 third valve
58 fourth valve
82 filter plates
83 central recess
84 filter means, filter cloth
85 connection channels
86 first pressure plate
88 second pressure plate
90 inlet opening
92 outlet openings
93 precipitate, filter cake
94 line
95 line
96 cooling apparatus
97 stirring apparatus
98 liquid level sensor

1. A method for depositing a coating of a first metal onto a workpiece (12) which exposes a second metal, comprising the following method steps:
a) providing a bath liquid (16) containing bath components comprising 5 ions of the first metal to be deposited, at least one complexing agent for the second metal and at least one acid,
b) depositing the coating of the first metal from the bath liquid (16) onto the workpiece (12),
c) feeding the bath liquid (16) into a settling tank (18),
d) cooling the bath liquid (16) in the settling tank (18) for the generation of a precipitate and of a filtrate, the precipitate comprising the second metal and the at least one complexing agent,
e) separating the precipitate from the filtrate by means of a filtration apparatus (20),
f) returning the filtrate to the bath liquid (16),
g) replenishing bath components to the bath liquid (16), characterised in that, for separating the precipitate from the filtrate, a pressure difference is generated via the filtration apparatus (20).

2. The method for depositing a coating of a first metal onto a workpiece (12) according to claim 1, characterised in that the precipitate is separated from the filtrate by means of pressure filtration.

3. The method for depositing a coating of a first metal onto a workpiece (12) according to claim 1, characterised in that the precipitate is separated from the filtrate by means of a chamber filter press (20).

4. The method for depositing a coating of a first metal onto a workpiece (12) according to claim 1, characterised in that the precipitate is separated from the filtrate at a pressure of from 9 bar to 16 bar.

5. The method for depositing a coating of a first metal onto a workpiece (12) according to claim 1, characterised in that the first metal is tin.

6. The method for depositing a coating of a first metal onto a workpiece (12) according to claim 1, characterised in that the second metal is copper.

7. The method for depositing a coating of a first metal onto a workpiece (12) according to claim 1, characterised in that at least one complexing agent is selected from the group comprising urea, thiourea and the 5 derivates thereof.

8. The method for depositing a coating of a first metal onto a workpiece (12) according to claim 1, characterised in that at least one acid is selected from the group comprising toluene sulfonic acid, methane sulfonic acid, derivates of methane sulfonic acid and aromatic sulfonic acids.

9. The method for depositing a coating of a first metal onto a workpiece (12) according to claim 1, characterised in that the precipitate being generated exhibits a copper content of at least 5% by weight.

10. The method for depositing a coating of a first metal onto a workpiece (12) according to claim 1, characterised in that the filtrate is separated from the precipitate via a filter cloth (84), wherein the filter cloth (84) is woven from polypropylene fibers.

11. The method for depositing a coating of a first metal onto a workpiece (12) according to claim 1, characterised in that the bath liquid is stored temporarily between the process steps d) and e) in a first storage tank (42).

12. The method for depositing a coating of a first metal onto a workpiece (12) according to claim 1, characterised in that the filtrate is stored temporarily between the process steps e) and f) in a second storage tank (46).

13. An arrangement for executing the method for depositing a coating of a first metal onto a workpiece (12) according to claim 1, wherein the arrangement comprises a bath tank (11) for holding a bath liquid (16) for depositing the coating of the first metal onto the workpiece (12), an apparatus (18) for cooling the bath liquid for generating a precipitate to be separated and a filtrate, a filtration apparatus (20) for separating the precipitate from the filtrate and an apparatus for returning the filtrate to the bath tank, characterised in that the filtration apparatus (20) is operable under pressure.

14. The arrangement according to claim 13, characterised in that the arrangement additionally comprises an apparatus for removing the bath liquid (16) from the bath tank (11) and for transferring the bath liquid to the apparatus (18) for cooling.

15. The arrangement according to claim 13 characterised in that the arrangement additionally comprises a first storage tank (42) connected 5 between the apparatus for cooling (18) and the filtration apparatus (20).

16. The arrangement according to claim 13, characterised in that the arrangement additionally comprises a second storage tank (46) connected downstream from the filtration apparatus (20).

17. The arrangement according to claim 13, characterised in that the arrangement additionally comprises at least one dosing apparatus (26) for feeding respectively at least one bath component.
